(19) United States
(12) Patent Application Publication
(10) Pub. No.: US 2006/0144094 A1
(43) Pub. Date: Jul. 6, 2006

(54) Method for the production of a hollow cylinder made of synthetic quartz glass with the aid of a holding device, and appropriate holding device for carrying out said method

(75) Inventors: Knut Roselieb, Gottingen (DE); Diana Kuffner, Wolfen (DE); Rene Sowa, Pouch (DE); Jan Plaschnick, Raguhn (DE); Steffen Schmutzler, Pouch (DE); Mirco Schubert, Stassfurt (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Tenevo GmbH, Hanau (DE)

(21) Appl. No.: 10/543,889

(22) PCT Filed: Jan. 20, 2004
(86) PCT No.: PCT/EP04/00419

§ 371 Date: Jul. 28, 2005

(30) Foreign Application Priority Data
Jan. 28, 2003 (DE) 103 03 290.8

(51) Int. Cl. C03B 11/08; C03B 37/018; C03B 37/075

(52) U.S. Cl. 65/414; 65/416; 65/421; 65/494; 65/374.1

(57) ABSTRACT

In a previously known method for producing a hollow cylinder made of synthetic quartz glass, a silicon-containing compound is flame-hydrolyzed and SiO₂ particles are deposited layer by layer on a rotating support, resulting in the production of an elongate porous soot body (5) having a central internal bore. Said soot body is dehydrated, doped, or vitrified, a process during which the soot body is held in a vertical direction inside a treatment oven by means of a holding device (9) comprising an elongate holding body (1) which protrudes into the internal bore of the soot body and is made of a material having a higher softening temperature than quartz glass. The aim of the invention is to create a method which is based on the previously known method and by means of which the purity of the hollow cylinder is maintained during said heating process while requiring little time and material for aftertreating the internal bore. Said aim is achieved by providing a gas-impermeable envelope (2) made of synthetic quartz glass between the holding body and the soot body. The holding device that is appropriate for carrying out the inventive method is characterized by the fact that a gas-impermeable envelope made of synthetic quartz glass is provided between the holding body and the soot body.

The present invention relates to a method for producing a hollow cylinder using a holding device of synthetic quartz glass in that an elongate porous soot body with a central internal bore is produced by flame hydrolysis of a silicon-containing compound and by layerwise deposition of SiO₂ particles on a rotating support, said soot body is dehydrated, doped or vitrified and held in this process in vertical orientation in a treatment furnace by means of a holding device which comprises an elongate holding body which protrudes into the internal bore of the soot body and is made of a material having a higher softening temperature than quartz glass.

Furthermore,the present invention relates to a holding device for carrying out the method, particularly for use in dehydrating, doping or vitrifying an elongate porous soot body with a central internal bore in vertical orientation, the device comprising an elongate holding body which protrudes into the internal bore of the soot body and is made of a material having a higher softening temperature than quartz glass.

Hollow cylinders or tubes of synthetic quartz glass are used as intermediate products for a great number of components for optical or chemical industry, and particularly for making preforms for optical fibers.

When a tubular soot body is produced according to the OVD (outside vapor deposition) method, fine SiO₂ particles are formed by flame hydrolysis of a silicon-containing start compound, such as SiCl₄, and are deposited in layers on a support rotating about its longitudinal axis. Such a method is e.g. described in DE 196 49 935 A1.

Aluminum oxide is often used as the material for the support because of its mechanical and chemical stability. However, supports consisting of the materials quartz, graphite or silicon carbide are also recommended. Before the further processing of the blank, e.g. by dehydration, doping, vitrification or collapsing of the internal bore, the support is usually removed.

Due to the manufacturing process the soot body has a high content of hydroxyl groups (OH groups). These show high absorption in the range of the standard working wavelength of optical fibers and must therefore be removed. According to DE 196 49 935 A1 the porous blank is subjected to a dehydration treatment by being held suspended in vertical orientation in a dehydration furnace from an embedded holder and by being exposed to a chlorine-containing atmosphere at a high temperature. The OH groups are substituted by chlorine in this process. Subsequently, the soot body treated in this way is introduced into an evacuatable vitrification furnace and is vitrified therein, thereby forming a transparent hollow cylinder of quartz glass.

DE 29 06 070 A1 describes an alternative device for holding a hollow cylinder of SiO₂ soot in vertical orientation during collapsing and fiber drawing. A tube piece which has a length of about 50 mm and is made from quartz glass is inserted into the bore of the hollow cylinder, the outer diameter of said tube piece corresponding approximately to the inner diameter of the internal bore, and the tube piece being provided with hump-like thickened portions at its end intended for insertion into the internal bore. For anchoring the quartz glass tube the hump-like thickened portions are twisted in the internal bore by about 90°, resulting in a connection resembling a bayonet lock.

A further device for holding a tubular soot body during vitrification is described in U.S. Pat. No. 5,076,824 A. A holding base is provided in this device and the hollow cylindrical soot body to be sintered is held standing in vertical orientation on said base. The holding base is connected to a rod which extends upwards through the bore of the soot body. Holding base and rod are provided with a layer of pyrolytically produced graphite or pyrolytically produced boron nitride. For vitrification the soot body is supplied, standing on the holding base and starting with its lower end, from above to an annular furnace and is softened and vitrified therein zonewise.

A method for producing a hollow cylinder and a device suited therefor according to the above-indicated type are described in EP 701 975 A2. The device comprises a holding rod which extends from above through the internal bore of a soot body and which is connected with its lower end to a holding base on which the soot body is standing with its lower face end. The holding rod consists of carbon fiber reinforced graphite (CFC) and is surrounded in the area of the internal bore of the soot body by a gas-permeable cladding tube of pure graphite. The cladding tube serves as a spacer during collapsing of the soot body, so that independently of the outer diameter of the holding rod it is possible to produce hollow cylinders with different inner diameters by varying the thickness of the cladding tube.

During vitrification of the soot body said body collapses onto the cladding tube of graphite. In this. process, contaminants which.are present in the graphite, particularly metallic impurities, may be released and transported into the quartz glass of the soot body. The dehydration treatment of the soot body in a halogen-containing atmosphere, which is normally carried out before vitrification, plays an important role insofar as impurities may get transported from the cladding tube into the soot body, which is promoted by the presence of fluorine or chlorine and the formation of volatile halogen compounds.

As a consequence, the purity to be achieved for the hollow cylinder may be limited in the known method by the content of contamination in the cladding tube of graphite.

After vitrification the cladding tube is removed in the known method, and the internal bore of the quartz glass tube is treated by drilling, grinding, honing or etching. This method is time-consuming and leads to losses in material.

It is therefore the object of the present invention to provide a method in which the purity of the hollow cylinder is maintained in the dehydration, doping or vitrification process and which simultaneously ensures a high dimensional stability of the hollow cylinder to be produced, so that the internal bore can be reworked without great losses in time or material.

Furthermore, it is the object of the present invention to provide a device for carrying out the method.

As for the method, this object, starting from the above-indicated method, is achieved according to the invention in that a gas-impermeable cladding of synthetic quartz glass is provided between the holding body and the soot body.

The treatment of the soot body comprises at least a heating process. This is a dehydration treatment, a doping step in which a dopant is introduced into the soot body, and/or a vitrification step in which the soot body is sintered to obtain a quartz glass cylinder. In an inventive modification of the known method the soot body is held during said heating process by means of a holding device in a corresponding treatment furnace, and the holding body protruding into the internal bore of the soot body is here surrounded at least in part by a quartz glass cladding. An essential aspect of this invention is that the holding body consisting of “foreign matter” with respect to the material of the soot body is shielded during the heating process at least in part from the soot body, namely by a cladding which consists of “specific material” of the soot body, i.e. of synthetic quartz glass.

To this end the holding body is surrounded with a gas-tight cladding of synthetic quartz glass. The quartz glass cladding is configured as a tube surrounding the holding body or as a gas-impermeable coating of the holding body. At any rate it shields the internal bore of the soot body from the holding body, thereby preventing transportation of contaminants into the soot body by direct contact with the holding body or through transportation via the gas phase (particularly by volatile metal chlorides).

Either the soot body is introduced completely into a heating zone formed inside the treatment furnace and is heated therein over its whole length at the same time, or the soot body is supplied to the heating zone, beginning with one end, and is heated therein zonewise.

The holding device of the soot body according to the invention is used in each or in individual ones of the subsequent heating processes. The dehydration treatment of the soot body is normally carried out in a halogen-containing, particularly fluorine- or chlorine-containing, atmosphere in a dehydration furnace. In a subsequent doping process for introducing a dopant into the soot body, the soot body is held by means of the holding device in a doping furnace. Doping may also be accompanied by dehydration of the soot body if a dopant (such as fluorine) is added to the dehydration atmosphere. Furthermore, in a vitrification process for sintering the soot body said body may be held by means of the holding device in a vitrification furnace. The use of the same furnace for dehydration, doping and/or vitrification is not ruled out. The holding body consists of a material which is dimensionally stable at the vitrification temperature for quartz glass!. Moreover, a high resistance to breakage and a high thermal shock resistance enhance operational reliability. The holding body comprises a rod or a tube. Rod or tube are configured as one part or are composed of several segments or pieces. The holding body may also comprise a cladding tube which surrounds the rod or tube. Crystalline materials, in particular, such as graphite or CFC, are appropriate materials.

After completion of the vitrification process holding body and quartz glass cladding are removed from the resulting quartz glass tube, e.g. by being withdrawn or drilled out. It is possible to carry out the vitrification process such that the internal bore of the soot body collapses onto the quartz glass cladding. In this particularly preferred case the quartz glass cladding melts on the inner wall of the original soot body, thereby forming the inner region and the inner wall in the finished quartz glass tube. Thus, this tube has a dimensionally stable internal bore which requires hardly any aftertreatment. This is supported by the fact that the inner wall is formed by the quartz glass cladding which, since it consists of dense, gas-impermeable quartz glass, is insensitive to the incorporation of contaminants from the holding body during the vitrification process or insensitive to a possible doping process.

A variant of the method has turned out to be particularly useful wherein the quartz glass cladding is formed as a cladding tube of quartz glass surrounding the holding body at least in part.

In a quartz glass cladding having the shape of a cladding tube of quartz glass, the density requirement can be satisfied in a particularly simple manner; moreover, a quartz glass tube can be produced and handled easily. The quartz glass tube extends along the internal bore of the soot body. Ideally, its length is at least the length of the internal bore; it may however also be shorter than the internal bore if this is expedient or required, for instance for holding the soot body.

Moreover, this variant of the method according to the invention facilitates the production of hollow cylinders of quartz glass having large wall thicknesses to be adjusted in an exact manner, since the overall wall thickness of the hollow cylinder of quartz glass is composed of the partial wall thicknesses of the employed cladding tube of quartz glass and of the wall thickness of the soot body after vitrification. The soot body can here be deposited on a support with a relatively large outer diameter, which has an advantageous effect on deposition efficiency.

Particularly in this respect it has also turned out to be advantageous when the quartz glass tube has a wall thickness ranging from 1 mm to 25 mm.

Wall thicknesses below said lower limits have a disadvantageous effect on handling and dimensional stability during use of the cladding tube, whereas in a cladding tube of quartz glass having a wall thickness of more than 25 mm the great weight is noticed in a disadvantageous way and impairs, in particular, the operational reliability of the holding device.

Preferably, the cladding tube of quartz glass surrounds the holding body with formation of an annular gap having a mean gap width of not more than 5 mm.

The holding body is removed after vitrification. Removal is all the simpler the wider the annular gap is between the cladding tube of quartz glass and the holding body. However, an increasing annular gap is accompanied on the one hand by the risk that the cladding tube of quartz glass and thus also the soot body tilt from the vertical, and the volume of the gas phase enriched with contaminants is enlarged in the annular gap on the other hand. The annular gap width is therefore chosen such that it is only as large as is absolutely necessary, but as small as possible. The indicated gap widths are mean values over length and radius.

During vitrification the internal bore of the soot body can be collapsed onto the cladding tube of quartz glass. In this case a variant of the method is preferred wherein the soot body surrounds the cladding tube of quartz glass with formation of an annular gap having a mean gap width of not more than 2 mm.

A large gap width facilitates the introduction of the cladding tube into the bore of the soot body. On the other hand, a minimal uncontrolled deformation of the soot body during collapsing of the internal bore is desired for reasons of dimensional stability of the quartz glass tube to be produced. Therefore, the width of said annular gap is chosen such that it is only as large as is absolutely necessary, but as small as possible. The data on the gap width also refer to a value averaged over length and radius.

In a particularly advantageous variant, the SiO₂ particles are deposited on the cladding tube of quartz glass in layers.

The cladding tube of quartz glass is here used as a support in the deposition process. Hence, the soot body is directly formed on the cladding tube of quartz glass, so that no gap remains between the cladding tube of quartz glass and the soot body and a certain connection exists right from the beginning. In this variant, the cladding tube of quartz glass need not be introduced into the internal bore of the soot body.

It has turned out to be useful when the quartz glass cladding extends along a substantial length of the internal bore of the soot body.

The upper and lower ends of the soot body are often rejected in the course of the further processing of the soot body. Thus a quartz glass cladding extending over the whole internal bore of the soot body is not required. However, a quartz glass cladding which extends over a substantial length of the internal bore more efficiently prevents contaminants from entering the soot body also through the gas phase. Substantial length of the internal bore is here understood as a length section between 80% and 100% of the overall length.

It has turned out to be advantageous in this respect when the soot body is standing with its lower face end on a support base connected to the holding body, from which the quartz glass cladding extends along the holding body.

The support base defines the beginning of the holding body and serves to fix the quartz glass cladding. Said cladding extends along the holding body, preferably over a substantial length thereof, which means a length section between 80% and 100% of the overall length of the holding body. The quartz glass cladding shields the soot body from contaminants.

The method of the invention primarily serves vitrification (sintering) of the soot body in the treatment furnace.

The soot body is introduced in this process either completely into a heating zone formed inside the vitrification furnace and is simultaneously heated therein over its whole length. Or, and this is the preferred variant, the soot body is supplied to the heating zone, beginning with an end, and is heated therein zonewise. The zonewise heating of the soot body facilitates the softening of gaseous components which due to the porosity of the soot body can migrate in front of the heating front and leave the soot body in the direction of the longitudinal axis and in the direction of the internal bore.

Equally preferably, the soot body is provided in the treatment furnace with a dopant. The dopant is introduced into the soot body preferably via the gas phase, the gas-impermeable cladding of synthetic quartz glass preventing the entrainment of gaseous contaminants from the holding body.

As for the holding device, the above-stated object starting from the device of the above-mentioned type is achieved according to the invention in that a gas-impermeable cladding of synthetic quartz glass is provided between the holding body and the soot body.

In an inventive modification of the known holding device, a quartz glass cladding is provided between the holding body protruding into the internal bore of the soot body and the soot body. An essential aspect of this invention is that the holding body which consists of “foreign matter” with respect to the material of the soot body is shielded at least in part from the soot body, namely by a cladding which consists of a “specific material” of the soot body, i.e. of synthetic quartz glass.

The quartz glass cladding is configured as a hollow cylinder surrounding the holding body, or as a gas-impermeable coating of the holding body. At any rate, it shields the internal bore of the soot body from the holding body, thereby preventing transportation of contaminants into the soot body by direct contact with the holding body or by transportation via the gas phase (particularly through volatile metal halides).

The holding body consists of a material which is dimensionally stable at the vitrification temperature for quartz glass. Moreover, a high resistance to breakage and a high thermal temperature shock resistance enhance operational reliability. The holding body comprises a rod or a tube. Rod or tube are configured as one part or are composed of several segments or pieces. The holding body may also comprise a cladding tube which surrounds rod or tube. Crystalline materials, in particular, such as graphite or CFC, are appropriate materials.

A particularly preferred variant of the device of the invention is characterized in that the cladding tube of quartz glass is part of the soot body.

The soot body is here produced by layerwise deposition of the SiO₂ particles on the cladding tube of quartz glass. The cladding tube serves as a support for the deposition process. A firm connection is established between the soot body and the cladding tube of quartz glass after the deposition process.

Further advantageous configurations of the holding device of the invention become apparent from the subclaims. Insofar as configurations of the holding device indicated in the subclaims copy the procedures mentioned in subclaims regarding the method according to the invention, reference is made for supplementary explanation to the above observations on the corresponding method claims.

The invention shall now be explained in more detail with reference to an embodiment and a drawing. As the sole figure of the drawing,

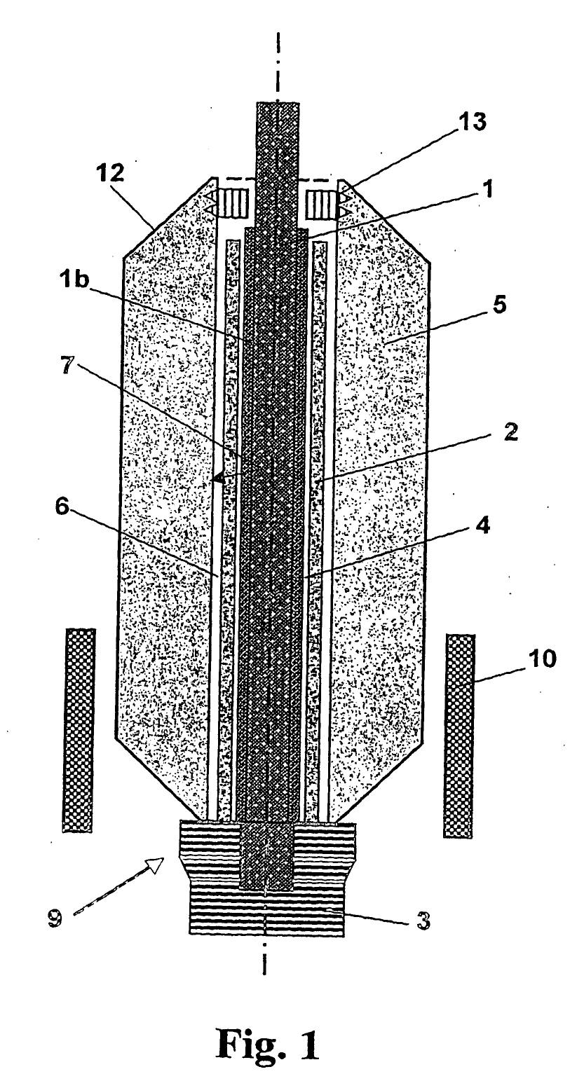

FIG. 1 shows an embodiment of the holding device according to the invention in a schematic view.

The holding device according to FIG. 1 is provided with reference numeral 9 on the whole. It comprises a support rod 1 of CFC, surrounded by a graphite tube lb and a holding base 3 of graphite.

The holding base 3 serves to receive the whole arrangement in a treatment space; in this embodiment, a doping and vitrifying furnace having an annular heating element 10. The holding base 3 is provided with a horizontally oriented receiving surface on which a tubular soot body (soot tube 5) of SiO₂ is seated in vertical orientation. Holding base 3 and support rod 1 are firmly interconnected by means of a thread.

The support rod 1 extends through the whole internal bore 7 of the soot body 5. The part of the support rod 1 that protrudes beyond the upper end 12 of the soot body 5 serves handling purposes. Due to its high tensile strength a relatively small diameter of the CFC support rod 1 of 30 mm is adequate.

The support rod 1 and the graphite tube 1b enclosing the same are surrounded by a cladding tube 2 of synthetic quartz glass. A gap 4 having a mean gap width of 0.5 mm is provided between the cladding tube 2 of quartz glass and the graphite tube 1b, and a gap 6 having a mean gap width of 0.8 mm is provided between the cladding tube 2 of quartz glass and the soot tube 5.

The cladding tube 2 of quartz glass consists of high-purity, synthetically produced, transparent and dense quartz glass. It has an outer diameter of 42.5 mm, a wall thickness of 1.5 mm, and its length is slightly shorter than that of the support rod 1 and the graphite tube 1b. The cladding tube 2 of quartz glass prevents direct contact between support rod 1 and soot tube 5, and it reduces the risk of contamination of the soot tube 5 by gaseous impurities diffusing out of the support rod 1.

The soot tube 5 has an inner diameter of 43 mm and a weight of about 100 kg. It can be transported by means of the holding device 9 and held in a treatment furnace.

A method for producing a hollow cylinder of synthetic quartz glass by using the holding device 9 shown in FIG. 1 shall now be described in more detail.

SiO₂ soot particles are formed by flame hydrolysis of SiCl₄ in the burner flame of a deposition burner, and said particles are deposited in layers onto a support rod of Al₂O₃ rotating about its longitudinal axis, thereby forming a soot body of porous SiO₂. After completion of the deposition method the support rod is removed. A transparent quartz glass tube is produced from the resulting soot tube 5, which has a density of about 25% of the density of quartz glass, by way of the method explained in the following in an exemplary manner:

The soot tube 5 is subjected to a dehydration treatment for removing the hydroxyl groups introduced due to the manufacturing process. To this end the soot tube 5 is introduced into a dehydration furnace and held therein by means of the holding device 9 in vertical orientation. The soot tube 5 is first treated at a temperature of about 900° C. in a chlorine-containing atmosphere. The treatment lasts for about eight hours.

Subsequently, the soot tube 5 pretreated in this way is introduced by means of the holding device 9 into a vitrification furnace with a vertically oriented longitudinal axis. The vitrification furnace can be evacuated and is equipped with an annular heating element 10 of graphite. The soot tube 5 is continuously fed from above, starting with its lower end, to the heating element 10 at a feed rate of 10 mm/min and is heated therein zonewise. The temperature of the heating element 10 is preset to 1600° C., whereby a maximum temperature of about 1580° C. is obtained on the surface of the soot body 5. A melt front migrates in this process inside the soot tube 5 from the outside to the inside and from the top to the bottom at the same time. The internal pressure inside the vitrification furnace is held at 0.1 mbar during vitrification by continuous evacuation. During vitrification the soot tube 5 shrinks onto the cladding tube 2 of quartz glass in zones, thereby establishing a firm melt connection with said tube. Gases that escape during vitrification are discharged via the still open-pore region of the soot tube 5 or via the gap between the cladding tube 2 of quartz glass and the soot tube 5, so that the formation of bubbles is avoided. During vitrification a holding nut 13 which has been screwed into the soot body 5 comes to rest on the upper end of the graphite tube 1b so that vitrification is subsequently carried out with a suspended soot body, as described in EP 701 975 A2.

The wall of the resulting quartz glass tube is composed of two regions. The outer region is formed by the quartz glass of the vitrified soot tube, 5, and the inner region by the quartz glass of the cladding tube 2. The inner surface is substantially planar and clean, so that mechanical aftertreatment is not needed.

The sintered (vitrified) hollow cylinder is subsequently elongated to have an outer diameter of 46 mm and an inner diameter of 17 mm. The resulting quartz glass tube shows high purity and a low hydroxyl group concentration, which permits use in the near-core region of a preform for optical fibers, for instance as a substrate tube for inside deposition by means of the MCVD method. Of course, the quartz glass tube is also suited for overcladding a core rod in fiber drawing or for producing a preform.

In a modification of the above-described method, a doping process is interposed between the dehydration treatment and the vitrification of the soot body, the soot tube being doped in this process with fluorine. To this end the soot tube is introduced into a doping and vitrifying furnace and held therein in vertical orientation by means of the inventive holding device. After purging and evacuation of the doping and vitrifying furnace, a fluorine compound, namely C₂F₆, is introduced into the furnace space, and the soot tube is heated therein to a temperature around 900° C. The treatment lasts for about eight hours.

In a further modification of the above-described flame hydrolysis and deposition process, a support tube of synthetic quartz glass having an outer diameter of 43 mm and an inner diameter of 30 mm is used as the substrate body for SiO₂ deposition, instead of the A1₂O₃ support. In the course of the deposition process a stable connection is established between the support tube of quartz glass and the soot body formed thereon. After completion of the deposition process the composite of quartz glass support tube and soot tube is subjected to a dehydration treatment and the soot tube is subsequently vitrified. The composite is here handled by means of a holding device which comprises a support rod of CFC which is enclosed by a graphite tube and which is connected to a holding base of graphite, as shown in FIG. 1.

The support rod and the graphite tube are also surrounded in this embodiment by a cladding tube of synthetic quartz glass which, in contrast to the above variant of the method, is not configured as a separate component, but is formed in this instance by the former support tube of quartz glass.

1. A method for producing a hollow cylinder ,said method comprising: producing an elongate porous soot body having a central internal bore by flame hydrolysis of a silicon-containing compound and layerwise deposition of SiO₂ particles on a rotating support, holding said soot body while said soot body is dehydrated, doped or vitrified in a vertical orientation in a treatment furnace by means of a holding device which comprises an elongate holding body which protrudes into the internal bore of the soot body and is made of a material having a higher softening temperature than quartz glass, and wherein a gas-impermeable cladding of synthetic quartz glass is provided between the holding body and the soot body.

2. The method according to claim 1, wherein the soot body is collapsed onto the quartz glass cladding during vitrification.

3. The method according to claim 1, wherein the quartz glass cladding is configured as a cladding tube of quartz glass which surrounds the holding body at least in part.

4. The method according to claim 3, wherein the cladding tube of quartz glass has a wall thickness ranging from 1 mm to 25 mm.

5. The method according to claim 3, wherein the cladding tube of quartz glass surrounds the holding body so as to define therebetween an annular gap having a mean gap width of not more than 5 mm.

6. The method according to claim 3, wherein the soot body surrounds the cladding tube of quartz glass so as to define therebetween an annular gap having a mean gap width of not more than 2 mm.

7. The method according to claim 3, wherein the SiO₂ particles are deposited in layers on the cladding tube of quartz glass.

8. The method according to claim 1, wherein the quartz glass cladding extends along a substantial length of the internal bore of the soot body.

9. The method according to claim 1, wherein the soot body is vitrified in the treatment furnace.

10. The method according to claim 1, wherein the soot body is provided with a dopant in the treatment furnace.

11. The method according to claim 1, wherein the soot body stands with a lower face end thereof on a support base connected to the holding body , from which the quartz glass cladding extends along the holding body.

12. A holding structure for use in the de-hydration, doping or vitrification of an elongate porous soot body having a central internal bore in a vertical orientation, said holding structure comprising: an elongate holding body which protrudes into the internal bore of the soot body and is made of a material having a higher softening temperature than quartz glass, and a gas-impermeable cladding of synthetic quartz glass supported between the holding body and the soot body.

13. The holding device according to claim 12, wherein the quartz glass cladding is configured as a cladding tube of quartz glass which surrounds the holding body at least in part.

14. The holding device according to claim 13, wherein the cladding tube of quartz glass has a wall thickness ranging from 1 mm to 25 mm.

15. The holding device according to claim 13, wherein the cladding tube of quartz glass surrounds the holding body so as to define therebetween an annular gap having a mean gap width of not more than 5 mm.

16. The holding device according to claim 13, wherein the soot body surrounds the cladding tube of quartz glass so as to define therebetween an annular gap having a mean gap width of not more than 2 mm.

17. The holding device according to claim 13, wherein the cladding tube of quartz glass is part of the soot body.

18. The holding device according to claim 12, wherein the quartz glass cladding extends along a substantial length of the internal bore of the soot body.

19. The holding device according to claim 12, wherein the holding body is connected to a support base from which the quartz glass cladding extends along the holding body.
